(19) United States
(12) Patent Application Publication
(10) Pub. No.: US 2017/0249594 A1
(43) Pub. Date: Aug. 31, 2017

(54) JOB SEARCH ENGINE FOR RECENT COLLEGE GRADUATES

(71) Applicant: Linkedln Corporation, Mountain View, CA (US)

(72) Inventors: Raymond Elery Ortigas, San Francisco, CA (US); Ada Cheuk Ying Yu, Santa Clara, CA (US); Xiao Yu Wang, Santa Clara, CA (US)

(21) Appl. No.: 15/055,055

(22) Filed: Feb. 26, 2016

(51) Int. Cl. G06Q 10/10; G06Q 50/00; G06F 17/30

(52) U.S. Cl. CPC G06Q 10/1053; G06F 17/30864; G06F 17/30867; G06Q 50/01

(57) ABSTRACT

A system filters profiles of an online business network as a function of recent college graduates who have recently become employed in first employment positions, and identifies codes associated with the first employment positions. The system filters job listings using the identified codes to identify job listings that are closed and similar to the first employment positions. The system stores the identified job listings that are similar to the first employment positions into a first subset of job listings, and analyzes the job descriptions in the first subset of job listings using a logistic regression to model job listings with predictor variables indicating whether the requirements expressed in the job descriptions—for example, requirements of previous work experience—are likely optional or mandatory. The system stores open job listings classified by the model as likely having optional requirements or mandatory requirements into a second subset of job listings, and displays the second subset of job listings to help recent college graduates with their job search.

### TECHNICAL FIELD

The present application relates generally to data processing systems, and in one specific example, to a social and/or business networking system that includes a job search engine that is especially suited for recent college graduates.

### BACKGROUND

Online social and professional networking services are becoming increasingly popular, with many such services boasting millions of active members. In particular, the professional networking website LinkedIn has become successful at least in part because it allows members to actively search for jobs.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the invention;

FIG. 2 is a block diagram of an example system, according to various embodiments;

FIGS. 3A and 3B are a flowchart illustrating an example method, according to various embodiments;

FIG. 3C is a flowchart illustrating another example method, according to various embodiments;

FIG. 4 illustrates an exemplary member profile page, according to various embodiments;

FIG. 5 illustrates an exemplary operation for training a prediction model, according to various embodiments;

FIG. 6 is a diagrammatic representation of a machine in the example form of a computer system within which a set of instructions, for causing the machine to perform any one or more of the methodologies discussed herein, may be executed.

### DETAILED DESCRIPTION

Example methods and systems are described for permitting recent college graduates to search for jobs, and for locating for the recent college graduates jobs that are suited to the recent college graduates. In the following description, for purposes of explanation, numerous specific details are set forth in order to provide a thorough understanding of example embodiments. It will be evident, however, to one skilled in the art that the present invention may be practiced without these specific details.

According to various exemplary embodiments, a job search engine for recent college graduates is configured to identify jobs that are particularly suited to the recent college graduates. These jobs can be jobs that are posted on or associated with a social network service such as LinkedIn. For example, the job search engine may identify types of jobs for which recently graduated college students were hired, and then recommend similar type jobs to other recently graduated college students.

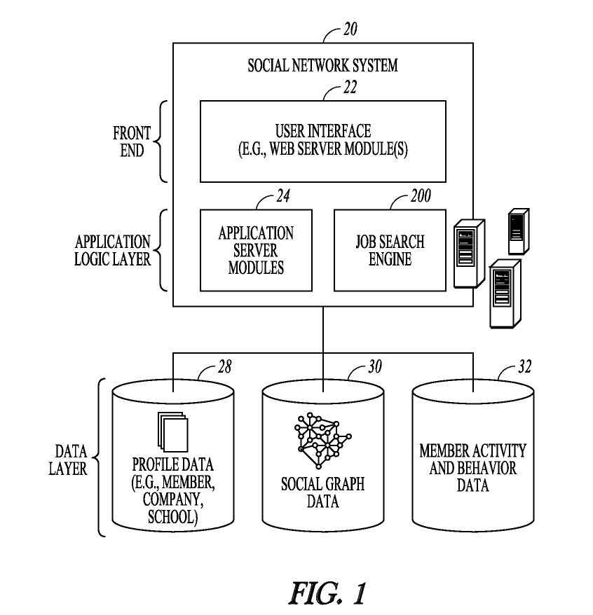

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 24, which, in conjunction with the user interface module(s) 22, generate various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32. This information may be used to classify the member as being in various categories. For example, if the member performs frequent searches of job listings, thereby exhibiting behavior indicating that the member is a likely job seeker, this information can be used to classify the member as a job seeker. This classification can then be used as a member profile attribute for purposes of enabling others to target the member for receiving messages or status updates. Accordingly, a company that has available job openings can publish a message that is specifically directed to certain members of the social network service who are job seekers, and thus, more likely to be receptive to recruiting efforts.

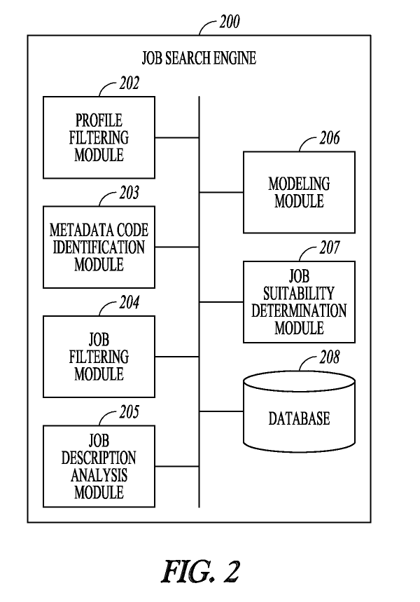

With some embodiments, the social network system 20 includes what is generally referred to herein as a job search engine 200. The job search engine 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 2, a job search engine 200 includes a profile filtering module or processor 202, a metadata code identification module or processor 203, a job filtering module or processor 204, a job description analysis module or processor 205, a modeling module or processor 206, a job suitability determination module or processor 207, and a database 208. The modules or processors of the job search engine 200 may be implemented on or executed by a single device such as a job search device, or on separate devices interconnected via a network. The aforementioned job search engine may be, for example, one or more client machines and/or application servers.

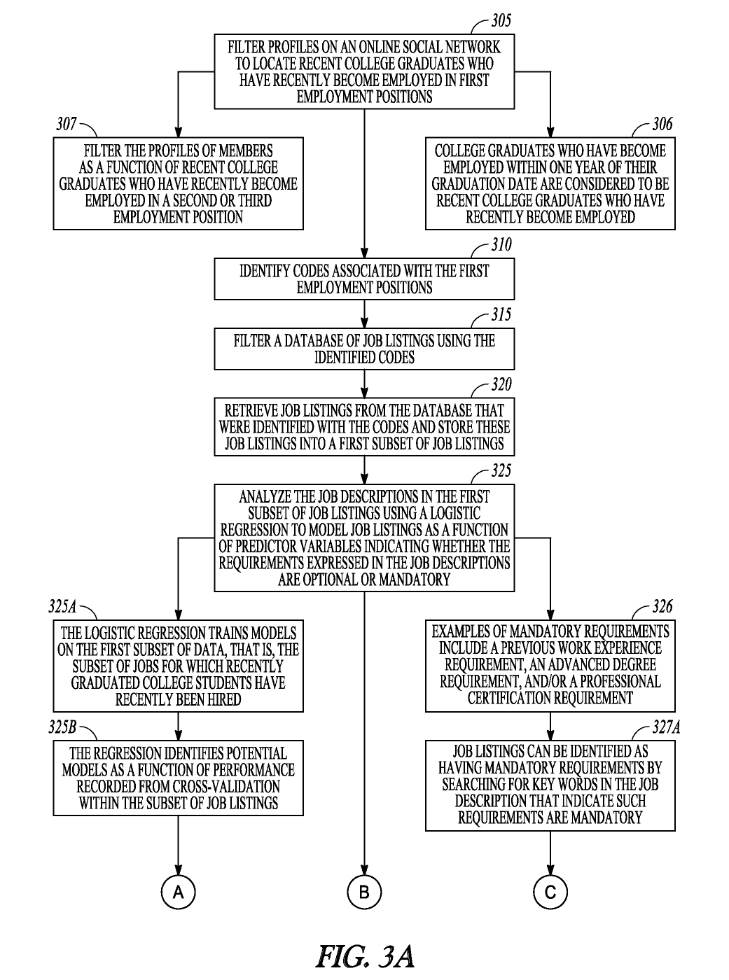

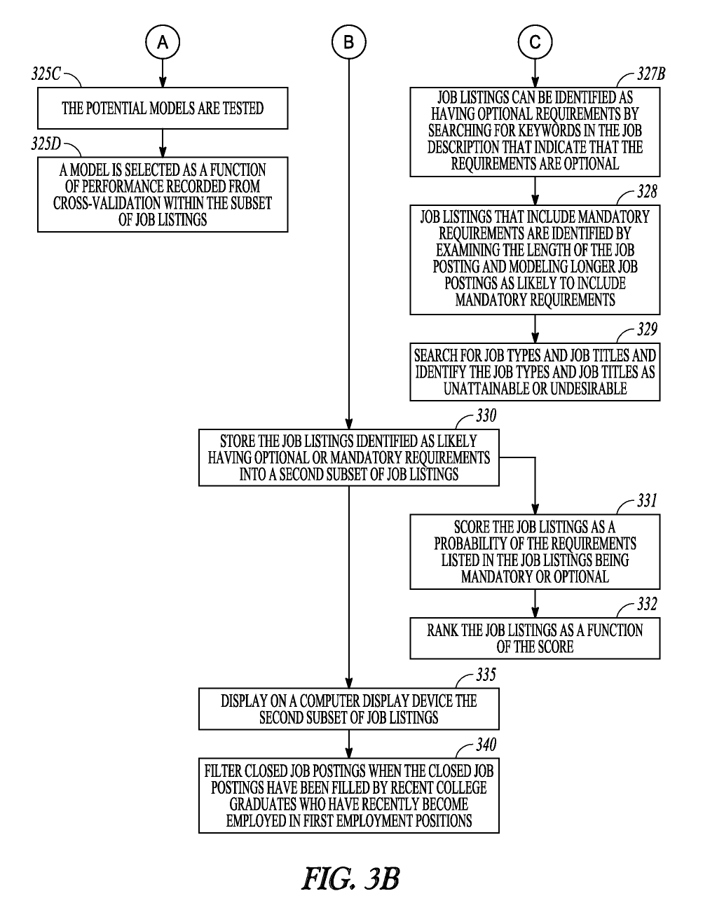

As described in more detail below, the profile filtering module 202 is configured to filter profiles of members of an online social or business network service to identify recent college graduates who have recently become employed in their first (or one of their first) employment positions. Thereafter, the metadata code identification module 203 identifies metadata codes that are associated with these first employment positions. The job filtering module 204 filters a database of job listings using the identified metadata codes to identify job listings that are similar to the first employment positions for which the recent college graduates have recently become employed. The job description analysis module 205 analyses the job descriptions of the identified job listings to identify keywords that may indicate that a job listing has optional or mandatory requirements (e.g., of previous work experience). A modeling module 206 invokes a logistic regression to model job listings (identified by the job description analysis module 205) and their probability of having optional or mandatory requirements. The job suitability determination module 207 takes a new job posting and predicts whether the job is likely suitable or not suitable for a recent college graduate. For a given job posting, it extracts features using the job description analysis module 205, it inputs the feature vector into a binary logistic regression model from the modeling module 206, and it records the prediction. The operation of each of the aforementioned modules of the job search engine 200 will now be described in greater detail in conjunction with FIGS. 3A, 3B, and 3C.

FIGS. 3A, 3B, and 3C are a block diagram illustrating features and operations of systems and methods that permit recent college graduates to search for jobs and to locate jobs that are suited to the recent college graduates. FIGS. 3A, 3B, and 3C include a number of process blocks 305-340 and 305C-315C. Though arranged substantially serially in the example of FIGS. 3A, 3B, and 3C, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now specifically to FIGS. 3A and 3B, at 305, the profile filtering module 202 of the online social networking system filters profiles of members or users of the online social network service to locate recent college graduates who have recently become employed in first employment positions.

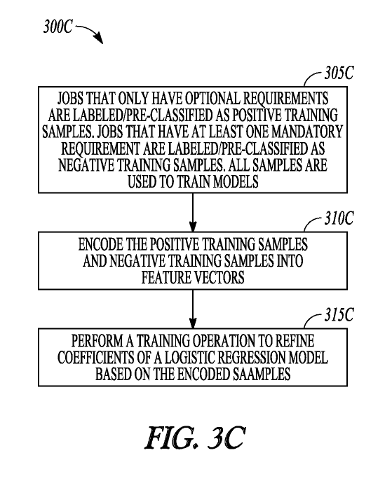

More specifically, each member of an online social network service (e.g., LinkedIn) may be associated with a member profile page that includes various information about that member. An example of a member profile page 400 of a member (e.g., a LinkedIn® page of a member “Jane Doe”) is illustrated in FIG. 4. As seen in FIG. 4, the member profile page 400 includes identification information 401, such as the member's name (“Jane Doe”), the member's current employment position (“Software Engineer at XYZ”), and geographic address/location information (“San Francisco Bay Area”). The member's profile page 400 also includes a photo area 402 for displaying a photograph of the member. Further, the member profile page 400 includes various sections (also known as fields). For example, member profile page 400 includes an experience section 411 including listings of experience positions (e.g., employment experience position 412), a skills and expertise section 421 including listings of various skills 422 of the member and endorsements of each of these skills received by other members, and an education section 431 including listings of educational credentials of the member (e.g., university degree or diploma 432 earned or currently being earned by the member). Note that the member profile page 400 is merely exemplary, and while the member profile page 400 includes certain sections or fields (e.g., experience sections and educations sections), it is apparent that these sections or fields may be supplemented or replaced by other sections or fields (e.g., a general portfolio section/field, a multimedia section/field, an art portfolio section/field, a music portfolio section/field, a photography portfolio section/field, and so forth). Those skilled in the art will understand that a member profile page may include other information, such as various identification information (name, username, email address, geographic address, networks, location, phone number, etc.), education information, employment information, resume information, activities, group membership, images, photos, preferences, news, status, links or URLs on the profile page, and so forth.

In some embodiments, by analyzing the member profile data and/or member profile page of a member of a social network service, the profile filtering module 202 may determine that a member is a recent college graduate who has recently become employed. The online social networking system will check a member's profile to determine if he or she has graduated from college (432), and then check to see if the member is employed (412). To determine if the member is a recently graduated and employed person, the online social networking system compares the graduation date or degree conferred date 432A in the member's profile to the employment start date 412A of an employment position in the member's profile. If the job start date is within a certain time of the member's graduation date, that member is considered to be recently employed.

Returning to FIGS. 3A and 3B, as indicated at 306, college graduates who have graduated and who have thereafter become employed within one year of their graduation date are considered to be recent college graduates who have recently become employed in a first employment position. At 307, the profile filtering module 202 of the online social networking system filters the profiles of members as a function of recent college graduates who have recently become employed in a second or third employment position. This feature captures recent college graduates who have been hired into a first position after graduation, then within a relatively short period of time left that first position to enter a second employment position. Since the recent college graduate did not stay long at the first position, then it is likely that he or she is still considered to be an entry level person, and the type of job that the recent college graduate got as his or her second employment position is likely to be suitable to other recent college graduates.

At 310, the metadata code identification module 203 identifies codes associated with these first employment positions. These codes can be in the form of metadata, and can consist of one or more parts that identify the type of job, the company, and the specific job title, for example. Then, at 315, the job filtering module 204 filters a database of job listings using the identified codes. The database can be the database 208 in FIG. 2. The filtering of the database 208 using the codes identifies job listings that are similar to the first employment positions for which the recent college graduates have recently become employed.

At 320, the online social networking system retrieves the job listings from the database that were identified with the codes, and stores these job listings, whose codes are similar to those of the first employment positions for which the recent college graduates have recently become employed, into a first subset of job listings. Then, at 325, the job description analysis module 205 and the modeling module 206 analyse the job descriptions in the first subset of job listings using a logistic regression to model job listings as a function of predictor variables indicating whether the requirements expressed in the job descriptions are optional or mandatory. That is, the logistic regression models a job listing's probability of having optional or mandatory requirements. As indicated at 326, examples of mandatory requirements include a previous work experience requirement, an advanced degree requirement, and/or a professional certification requirement. As indicated at 327A, job listings can be identified as having mandatory requirements by searching for key words in the job description that indicate such requirements are mandatory. Such key words can include “must,” “minimum,” and “at least.” Similarly, at 327B, job listings can be identified as having optional requirements by searching for keywords in the job description that indicate that the requirements are optional. Such keywords can include “should,” “preferably,” “ideally,” and/or “equivalent.” In another embodiment, as indicated at 328, job listings that include mandatory requirements are identified by examining the length of the job posting and modeling longer job postings as likely to include mandatory requirements.

FIG. 3C is a flowchart illustrating an example method 300C, consistent with various embodiments described above. The method 300C may be performed at least in part by, for example, the modeling module 206 illustrated in FIG. 2 (or an apparatus having similar modules, such as a client machine and/or application server). In operation 305C, the modeling module 206 ingests job descriptions, which are labeled or pre-classified (by a trusted individual or set of individuals) as having optional requirements, and considers these descriptions as positive training samples. In operation 310C, the modeling module 206 encodes the positive training samples into feature vectors, where features are selected indicators of optional or mandatory requirements, for example. In operation 315C, the modeling module performs a training operation to refine coefficients of a logistic regression model, based on the encoded samples.

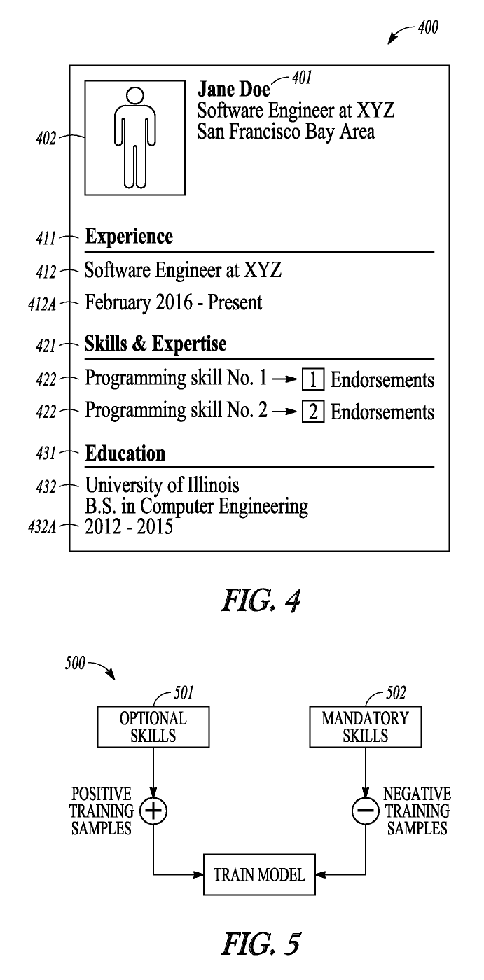

Additionally, according to various exemplary embodiments, job descriptions that have mandatory requirements may be labelled or pre-classified (by a trusted individual or set of individuals) as negative training samples for training the model. In other words, the negative training data may be treated by the modeling module 206 as representative samples of job descriptions that have mandatory requirements, and the modeling module 206 may train the model based on such data (e.g., by refining the coefficients of the logistic regression model). In this way, the model may be later used to determine whether a given job description has mandatory requirements, analyzing the same types of features or indicators used when training the model on other job descriptions. For example, as illustrated at 500 in FIG. 5, job descriptions with mandatory requirements 502 may be utilized as negative training samples for training a model, and job descriptions with optional requirements 501 may be utilized as positive training samples for training a model.

Returning again to FIGS. 3A and 3B, at 330, the online social networking system stores the job listings identified as likely having optional or mandatory requirements expressed in the job descriptions into a second subset of job listings. At 335, the online social networking system displays on a computer display device the second subset of job listings. This second set of job listings contains jobs for which recent college graduates are more likely to be considered since the system determined that other recent college graduates were hired into similar jobs, and these jobs are sorted or filtered for consideration by recent college graduates based on their likelihood of having optional or mandatory requirements. This presentation of the second set of job listings is likely to be useful to a recent college graduate who is searching for his or her first employment position.

As indicated at 325A-325D, the steps in the analysing of the job descriptions in the first subset of job listings using a logistic regression to model job listings as a function of features or indicators or optional or mandatory requirements are as follows. At 325A, the logistic regression trains models on the first subset of data, that is, the subset of jobs whose metadata codes are similar to those of the jobs for which recently graduated college students have recently been hired. At 325B, the regression identifies potential models as a function of performance from cross-validation within a subset of job listings. At 325C, the potential models are tested, and at 325D, a model is selected as a function of performance from cross-validation within a subset of job listings.

More specifically, the modeling module 206 performs a prediction modeling process based on the indicators (i.e., of optional or mandatory requirements associated with job descriptions) in order to identify job listings that are suitable to recent graduates and job listings that are not suitable to recent graduates. According to various exemplary embodiments described in more detail below, the aforementioned modeling process may include training a model (e.g., a logistic regression model) using positive data samples (job descriptions with optional requirements) and negative data samples (job descriptions with mandatory requirements) which may exhibit none, some, or all of the features or indicators, in varying magnitude. Thereafter, the trained model may analyse a particular job description posted on the online social network service to predict a likelihood or probability that the particular job posting will be suitable or not suitable to a recent college graduate. This may then be repeated for all the job listings on the online social network service, in order to identify all job listings for which recent college graduates may be suited.

The modeling module 206 may use any one of various known modeling techniques to perform the modeling. For example, according to various exemplary embodiments, the modeling module 206 may apply a statistics-based machine learning model such as a logistic regression model to the indicators. As understood by those skilled in the art, logistic regression is an example of a statistics-based machine learning technique that uses a logistic function. The logistic function is based on a variable, referred to as a logit. The logit is defined in terms of a set of regression coefficients of corresponding independent predictor variables. Logistic regression can be used to predict the probability of occurrence of an event given a set of independent/predictor variables. A highly simplified example machine learning model using logistic regression may be ln[p/(1−p)]=a+BX+e, or [p/(1−p)]=exp(a+BX+e), where In is the natural logarithm, logₑₓₚ, where exp=2.71828 . . . , p is the probability that the event Y occurs, p(Y=1), p/(1−p) is the “odds ratio”, ln[p/(1−p)] is the log odds ratio, or “logit”, a is the coefficient on the constant term, B is the regression coefficient(s) on the independent/predictor variable(s), X is the independent/predictor variable(s), and e is the error term. In some embodiments, the independent/predictor variables of the logistic regression model may be data associated with the job descriptions of job listings (where the data may be encoded into feature vectors). The regression coefficients may be estimated using maximum likelihood or learned through a supervised learning technique from the indicators, as described in more detail below. Accordingly, once the appropriate regression coefficients (e.g., B) are determined, the features included in a feature vector (e.g., data associated with a job description of a social network service) may be plugged into the logistic regression model in order to predict the probability that the event Y occurs (where the event Y may be, for example, a particular job listing has optional requirements and therefore is suitable for a recent college graduate). In other words, provided a feature vector including various requirements associated with a particular job listing, the feature vector may be applied to a logistic regression model to determine the probability that the particular job listing is suitable to a recent college graduate. Logistic regression is well understood by those skilled in the art, and will not be described in further detail herein, in order to avoid occluding various aspects of this disclosure. The modeling module 206 may use various other modeling techniques understood by those skilled in the art to predict whether a particular job listing is suitable for a recent college graduate. For example, other modeling techniques may include other machine learning models such as a Naïve Bayes model, a support vector machines (SVM) model, a decision trees model, and a neural network model, all of which are understood by those skilled in the art.

According to various embodiments described above, the job listing indicators may be used for the purposes of both training the model (for generating and refining a model and/or the coefficients of a model) and using the trained model (for predicting whether a particular job listing is suitable for a recent college graduate). For example, if the modeling module 206 is utilizing a logistic regression model (as described above), then the regression coefficients of the logistic regression model may be learned through a supervised learning technique from the indicators. Accordingly, in one embodiment, the job description analysis module 205 may operate in an off-line training mode by assembling the job description indicators into feature vectors. (For the purposes of training the system, the system generally needs both positive examples of job listings having optional requirements, as well as negative examples of job listings having mandatory requirements, as will be described in more detail below). The feature vectors may then be passed to the modeling module 206, in order to refine regression coefficients for the logistic regression model. For example, statistical learning based on the Stochastic Gradient Descent technique may be utilized for this task. Thereafter, once the regression coefficients are determined, the job suitability determination module 207 may operate to perform online (or offline) inferences based on the trained model (including the trained model coefficients) on a feature vector representing a job listing of the online social network service. For example, according to various exemplary embodiments described herein, the job suitability determination module 207 is configured to predict the likelihood that a particular job listing is suitable to a recent college graduate, based on the job description indicators of the particular job listing compared to the contributions or weights of these indicators in the job listings that were utilized to train the model. In some embodiments, if the probability that the particular job listing is suitable for a recent college graduate is greater than a specific threshold (e.g., 0.5, 0.8, etc.), then the job suitability determination module 207 may classify that particular job listing as being suitable for a recent college graduate. In other embodiments, the job suitability determination module 207 may calculate a score for the particular job listing, based on the probability that the particular job listing is suitable for a recent college graduate. Accordingly, the job suitability determination module 207 may repeat this process for all the job listings of an online social network service.

According to various exemplary embodiments, the off-line process of training or retraining the model based on the job description indicators may be performed periodically at regular time intervals (e.g., once a month), or may be performed at irregular time intervals, random time intervals, continuously, etc. Since job listing indicators may change over time based on changes in the listing of jobs on the social networking system, it is understood that the model itself may change over time (based on the current recruiting intent indicators being used to train the model). The descriptions of job listings may change over time because, for example, industry practice within a field may change, or features, products and technology of the online social network service may change, and so on.

As described above, for the purposes of training the logistic regression model, the model generally requires both positive examples of job listings having optional requirements, as well as negative examples of job listings having mandatory requirements. In other words, the job listing examples may be treated by the job suitability determination module 207 as representative samples of job listings associated with optional requirements and those associated with mandatory requirements. The job suitability determination module 207 may train the model based on the indicators or predictor variables contained in these job listings (e.g., by refining the coefficients of the prediction model). In this way, the model may be later utilized to analyse data associated with a given job listing, in order to determine the job contributions of the values of the predictor variables in this particular listing, and to thus determine whether the given job listing is suitable for a recent college graduate.

Returning again to FIGS. 3A and 3B, at 340, the online social networking system filters closed job postings when the closed job postings have been filled by recent college graduates who have recently become employed in first employment positions. That is, even if a job position has been filled and it is now closed, the online social networking system still considers that posting in its analysis if it was filled by a recent college graduate who was recently employed in that position. This closed job posting is then used with others to derive the first subset of job listings (whose metadata codes are similar to those of jobs for which recent college graduates have recently been hired).

At 331 and 332, the online social networking system ranks the jobs whose metadata codes are similar to those jobs for which recent college graduates have recently been hired. Specifically, at 331, the online social networking system scores the job listings whose metadata codes are similar to those jobs for which recent graduates have recently been hired as a probability of the requirements or skills listed in the job listings being mandatory or optional. For example, if a job listing has a description with one or more of the term “must” in it, that job listing will likely be scored lower (since a recent college graduate is not likely to have many of the required skill sets listed after the word “must”). Similarly, if a job listing has a description with one or more or the term “preferably” in it, that job listing will likely be scored higher (since a recent college graduate who does not have many skill sets yet will more likely be considered for such a position). Then, at 332, the job listings of recent college graduates who have recently been hired are ranked as a function of the score. Consequently, job listings with optional requirements are ranked higher and presented to the recent college graduate who is searching for a job because it is less likely that that recent college graduate will land a job with mandatory requirements.

At 329, the online social networking system's analysis of the job descriptions of the jobs that have recently been filled by recent college graduates involves searching for job types and job titles, and identifying the job types and job titles as unattainable or undesirable. For example, if the job description includes the terms “senior,” “CEO,” or “group leader,” then it is likely that the recent college graduate is not qualified for that job. Similarly, a recent college graduate may not be interested in jobs with descriptions of “chef,” “mechanic,” or “grocer.”

In summary, an embodiment of an online social networking system identifies jobs similar to those for which recent college graduates have been recently hired, analyses the descriptions of those jobs and creates models based on that analysis, and uses the models to identify other job listings that may be the type of job suitable to a recent college graduate. This embodiment improves the functionality of the computerized online social networking service because it displays to a recent college graduate jobs for which he or she is more likely to be hired. By searching for, locating, and displaying only the jobs for which a recent college is likely to be hired, and not searching for, locating, and displaying jobs for which the recent college graduate is not likely to be hired, the operation of the computer hardware on which the online social networking system executes functions much more efficiently.

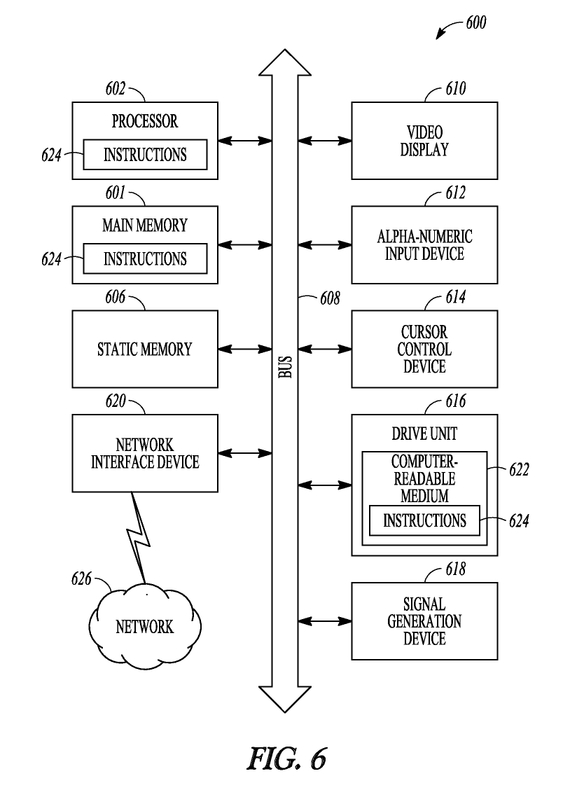

FIG. 6 is a block diagram of machine in the example form of a computer system 600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard or a touch-sensitive display screen), a user interface (UI) navigation device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions and data structures (e.g., software) 624 embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A system comprising:
one or more processors; and
a computer readable medium storing instructions that, when executed by the one or more processors, cause the system to perform operations comprising:
filtering profiles of members of an online business network service as a function of recent college graduates who have recently become employed in first employment positions;
identifying codes associated with the first employment positions;
filtering a database of job listings using the identified codes to identify job listings that are similar to the first employment positions for which the recent college graduates have recently become employed;
storing the identified job listings that are closed and similar to the first employment positions for which the recent college graduates have recently become employed into a first subset of job listings;
analyzing the job descriptions in the first subset of closed job listings using a logistic regression to model job listings with predictor variables indicating whether the requirements expressed in the job descriptions are likely optional or mandatory;
storing open job listings classified by the model as likely having optional requirements or mandatory requirements into a second subset of job listings; and
displaying on a computer display device the second subset of job listings.

2. The system of claim 1, wherein the recent college graduates who have recently become employed in first employment positions have graduated and have become employed in the first employment positions within a time period of an immediately prior twelve months.

3. The system of claim 1, wherein the first employment positions are identified on profiles of the members.

4. The system of claim 1, wherein the mandatory requirements comprise one or more of a previous work experience requirement, an advanced degree requirement, and a professional certification requirement.

5. The system of claim 1, wherein the identifying job listings having mandatory requirements comprises identifying key words indicating that the requirements are mandatory.

6. The system of claim 1, wherein the identifying job listings having mandatory requirements comprises a function of a length of the job posting and identifying longer job postings as likely to include mandatory requirements.

7. The system of claim 1, wherein the identifying job listings having optional requirements comprises identifying key words indicating that the requirements are optional.

8. The system of claim 1, wherein the analyzing the job descriptions in the first subset of closed job listings using a logistic regression to model job listings with predictor variables indicating whether the requirements expressed in the job descriptions are likely optional or mandatory comprises:
training logistic regression models on the first subset of data;
identifying potential models as a function of performance recorded from a cross-validation within the subset of job listings;
testing the potential models; and
selecting a model as a function of performance recorded from cross-validation within the subset of job listings.

9. The system of claim 1, wherein the instructions cause the system to filter closed job postings of the online business network service as a function of their similarity to jobs filled by recent college graduates who have recently become employed in first employment positions in order to derive the first subset of job listings.

10. The system of claim 1, comprising instructions to cause the system to:
score the open job listings in the second subset of job listings as a probability of requirements within the job listings being mandatory or optional; and
rank the job listings in the second subset of job listings as a function of the score.

11. The system of claim 1, wherein the analyzing the job descriptions in the first subset of job listings comprises searching for job types and job titles and identifying the job types and job titles as unattainable or undesirable.

12. The system of claim 1, wherein the filtering of profiles of members of the online business network service as a function of recent college graduates comprises filtering profiles as a function of recent college graduates who have recently become employed in non-first employment positions.

13. A process comprising
filtering profiles of members of an online business network service as a function of recent college graduates who have recently become employed in first employment positions;
identifying codes associated with the first employment positions;
filtering a database of job listings using the identified codes to identify job listings that are similar to the first employment positions for which the recent college graduates have recently become employed;
storing the identified job listings that are closed and similar to the first employment positions for which the recent college graduates have recently become employed into a first subset of job listings;
analyzing the job descriptions in the first subset of closed job listings using a logistic regression to model job listings with predictor variables indicating whether the requirements expressed in the job descriptions are likely optional or mandatory;
storing open job listings classified by the model as likely having optional requirements or mandatory requirements into a second subset of job listings; and
displaying on a computer display device the second subset of job listings.

14. The process of claim 13, wherein the recent college graduates who have recently become employed in first employment positions have graduated and have become employed in the first employment positions within a time period of an immediately prior twelve months.

15. The process of claim 13, wherein the mandatory requirements comprise one or more of a previous work experience requirement, an advanced degree requirement, and a professional certification requirement.

16. The process of claim 13, wherein the identifying job listings as having mandatory requirements comprises identifying keywords indicating that the requirements are mandatory and wherein the identifying job listings as having optional requirements comprises identifying key words indicating that the requirements are optional.

17. The process of claim 13, wherein the identifying job listings having mandatory requirements comprises a function of a length of the job posting and identifying longer job postings as likely to include mandatory requirements.

18. The process of claim 13, comprising filtering closed job postings of the online business network service as a function of their similarity to jobs filled by recent college graduates who have recently become employed in first employment positions in order to derive the first subset of job listings.

19. The process of claim 13, comprising:
scoring the job listings in the second subset of job listings as a probability of requirements within the job listings being mandatory or optional; and
ranking the job listings in the second subset of job listings as a function of the score.

20. The process of claim 13, wherein the analyzing the job descriptions in the first subset of job listings comprises searching for job types and job titles and identifying the job types and job titles as unattainable or undesirable;
and wherein the filtering of profiles of members of the online business network service as a function of recent college graduates comprises filtering profiles as a function of recent college graduates who have recently become employed in non-first employment positions.
